(19) United States
(12) Patent Application Publication
(10) Pub. No.: US 2019/0343278 A1
(43) Pub. Date: Nov. 14, 2019

(54) PET STEPS

(71) Applicant: LARRY LUBKERT, newburgh, NY (US)

(72) Inventor: LARRY LUBKERT, newburgh, NY (US)

(73) Assignee: Freedom Stairs, INC., Newburgh, NY (US)

(21) Appl. No.: 16/405,458

(22) Filed: May 7, 2019

Related U.S. Application Data
(63) Continuation-in-part of application No. 29/672,349, filed on Dec. 5, 2018.
(60) Provisional application No. 62/669,368, filed on May 9, 2018.

(51) Int. Cl. A47B 88/413; A01K 15/02

(52) U.S. Cl. CPC A47B 88/413; A01K 15/02

(57) ABSTRACT

A retractable and collapsible pet stool that is slidable across the floor. In the “two step” embodiment, which can be increased to three or four steps or more, a first step is provided that is supported on three sides by support members of substantially of equal length to provide a substantially horizontal first step. A second step is provided that is supported on three sides by support members of substantially of equal length to provide a substantially horizontal second step. The support members of the second step are sufficiently shorter than the support members for the first step to permit the second step to selectively slide under and be removed from under the first step. The steps are detachable from each other to permit placement in different areas of the premises.

### RELATED APPLICATIONS

This application claims priority of provisional application 62/669,368 entitled PET STEPS filed on May 9, 2018, the entire disclosure of which is incorporated herein by reference. This application is also a Continuation-In-Part of design patent application No. 29/672,349 entitled PET STEPS filed on Dec. 5, 2018, now pending, the entire disclosure of which is incorporated herein by reference.

### SPECIFICATION

### Field of the Invention

This invention relates to a retractable step stool for use by a pet that permits the pet to climb up on beds, couches, etc. that is of simple construction, movable, collapsible, expandable and disassembled into individual steps and provides a secure support, particularly for heavy pets, and pets with orthopedic issues, such as pets with pre or post knee or hip surgery or pets with arthritis.

### Background of the Invention

Previous efforts at making pet steps or staircases have been made using one piece plastic and wood versions which are difficult to move and position into place due to their size as well as having small steps and associated tread areas and are not adaptable to different size pets.

The following references may be relevant to this invention:

U.S. Pat. No. 1,293,967 to Stadler

U.S. Pat. No. 1,320,008 to Holwick

U.S. Pat. No. 1,441,670 to Egner

U.S. Pat. No. 1,973,628 to Hindle

U.S. Pat. No. 2,563,436 to Toth

U.S. Pat. No. 4,846,304 to Rasmussen

U.S. Pat. No. 5,660,405 to Campbell

U.S. Pat. No. 5,735,586 to Cheng

U.S. Pat. No. 5,755,498 to Cutler

U.S. Pat. No. 6,354,041 to Guiles

U.S. Pat. No. 6,378,720 to Santa Cruz

U.S. Pat. No. 6,425,457 to Lundry

U.S. Pat. No. 6,964,246 to Wolfington

U.S. Pat. No. 7,815,266 to Sun

U.S. Pat. No. 8,141,680 to Wigutoff

US 2008/0164724 to Burnett

US 2010/0083913 to Gibson

US 2012/0234630 to Havens

US 2015/0033786 to Mansfield

### SUMMARY OF THE INVENTION

Other features and advantages of the present invention will become apparent from the following more detailed description, taken in conjunction with the accompanying drawings, which illustrate, by way of example, the principles of the invention.

The pet staircase of the present invention can have two or more steps and each step is always in direct contact with the floor it is placed on for support thereof. The pet staircase is not a drawer type system that cantilevers each pull-out level and requiring extending tracks, wheels or other supportive means. All of the steps are always in direct contact with the floor surface whether open or closed, allowing the pet's weight to be applied to the step in use rather than the weight being transferred to tracks connected to the main step box like a dresser drawer. Each step can be separated from the other steps to provide flexibility for different sized pets, varying climbing abilities of the pet and surfaces that are required to be accessed by the pet. The current invention's configuration provides for a much more stable environment which creates confidence and assurance to a pet as well as its owner. All bottoms of steps and support rails may have nylon or felt strips or similar materials for ease of movement while deploying the steps.

The geometric relationship between the rise and tread as well as the width of each step is important in designing the pet step staircase of this invention. The rise is the vertical dimension of a step and the tread is the depth of the step when walking upwards and downwards. Although smaller or larger step rises may be applied to accommodate very small or very large pets.

Previous attempts at designing pet steps have all used dimensions similar to the architectural design for a human staircase. Such rise and tread dimensions are awkward and inappropriate to use when applied to four legged animal. The current invention provides for a longer or deeper tread platform step allowing for a four legged pet to easily, comfortably and securely traverse up or down the steps. The steps of the present invention are proportioned to provide a secure, stable and easily accessible step means. The proportions can be varied to accommodate particular pets, e.g., a small cat, a big St. Bernard.

Broadly, the retractable step stool of this invention rests on a floor and is slidable across the floor. In the “two step” embodiment, which can be increased to three or four steps or more, a first step is provided having a first top tread panel, a front edge, a rear opposing edge and opposing side edges. The step includes a first rear support member mounted along the rear edge extending to the floor and first side support members mounted along each of the opposing side edges, each extending to the floor. The first rear support member and first side support members are substantially of equal length to provide a substantially horizontal first top tread panel and are slidably supported on the floor.

A second step having a second top tread panel having a front edge, a rear opposing edge and opposing side edges is provided. The step includes a second rear support member mounted along the rear edge extending to the floor and a second side support member mounted along each of the opposing side edges, each extending to the floor.

The second rear support member and second side support members are substantially equal length to provide a substantially horizontal second top tread panel and are also slidably supported on the floor. The second rear support member and second side support members are sufficiently shorter than the first rear support member and first side support members and the second top tread panel is sufficiently smaller than the first top tread panel to permit the second step to selectively slide under and be removed from under the first step.

Similar structures are provided for a greater number of steps. The steps nest within each other, can be collapsed into a single structure and can be removed from each other to decrease the number of steps or used individually.

### BRIEF DESCRIPTION OF THE DRAWINGS

Further aspects, features and advantages of the present invention will become even more apparent with reference to the following detailed description and the accompanying drawings.

FIG. 1. Shows an embodiment of the retractable step stool for use by a pet of this invention that is portable and has three extendable pet steps, in use by a large dog.

FIG. 2. Shows a side view of the embodiment of the pet steps of FIG. 1 with the middle and lower steps fully extended.

FIG. 3. Shows a top view of the embodiment of the pet steps of the preceding Figures with the middle and lower steps fully extended.

FIG. 4. Shows a front view of the embodiment of the pet steps of the preceding Figures with the middle and lower steps fully collapsed within the upper step.

FIG. 5. Shows a bottom view of the embodiment of the pet steps of the preceding Figures with the middle and lower steps fully collapsed within the upper step.

FIG. 6. Shows an interior view of the embodiment of the pet steps of the preceding Figures with the middle and lower steps removed from the upper step.

FIG. 7. Shows a front view of the embodiment of the pet steps of the preceding Figures with the middle and lower steps fully collapsed within the upper step and with the front panels removed.

FIG. 8. Shows a front view of the embodiment of the pet steps of the preceding Figures with the lower step removed and the middle step fully collapsed within the upper step and with the front panel removed.

FIG. 9. Shows a front view of the embodiment of the pet steps of the preceding Figures with the lower step and the middle step removed.

FIG. 10. Shows a front view of the embodiment of the pet steps of the preceding Figures showing the middle step fully extended and the lowest step removed.

FIG. 11. Shows a front view of the middle step of the embodiment of the pet steps of the preceding Figures.

FIG. 12. Shows a side view of the upper step of the embodiment of the pet steps of the preceding Figures.

FIG. 13. Shows a side view of the middle step of the embodiment of the pet steps of the preceding Figures.

FIG. 14. Shows a top front view image of the lower step of the embodiment of the pet steps of the preceding Figures.

FIG. 15. Shows a top side view of the lower step of the embodiment of the pet steps of the preceding Figures.

FIG. 16. Shows a front view of another embodiment of the pet steps of this invention, a two-step embodiment for smaller pets, with the lower step fully collapsed within the upper step and with the front panel removed.

FIG. 17. Shows a top view of the embodiment of the pet steps shown in FIG. 16, with the lower step front panel removed, fully collapsed within the upper step and having a compartment for holding items located below the upper step platform which may be pivoted to a raised position to obtain access to the compartment.

FIG. 18.-19. Shows top views of the embodiment of the pet steps shown in FIG. 16-17., with the lower step front panel removed and fully collapsed within the upper step and with the upper step pivoted open to reveal a compartment within the upper step for holding items.

FIG. 20. Shows a front perspective view of the upper step of the embodiment of FIG. 1 showing some of the structural elements.

FIG. 21 Shows a front perspective view of the embodiment of FIG. 1 of the middle step of this invention showing some of the structural elements.

FIG. 22 Shows a front perspective view of the lower step of the embodiment of FIG. 1 (that can also be utilized by the embodiment of FIG. 16) showing some of the structural elements.

FIG. 23 is a perspective view of the embodiment of this invention depicted in FIGS. 1-15 as seen from the top, front and right sides in a first expanded position.

FIG. 24 is a right side view thereof of the embodiment of this invention depicted in FIGS. 1-15, the left side view being a mirror image.

FIG. 25 is a top plan view thereof.

FIG. 26 is a front view thereof.

FIG. 27 is a rear view thereof.

FIG. 28 is a perspective view showing the embodiment of this invention depicted in FIGS. 1-16 in a second collapsed position.

FIG. 29 is a perspective view of another embodiment of this invention similar to FIG. 1-16, with an additional step, as seen from the top, front and right sides in a first expanded position.

FIG. 30 is a perspective view thereof showing the embodiment depicted in FIG. 29 in a second collapsed position.

The drawings are not presented to scale but are only used to illustrate the principles of the invention. In the drawings, like reference numbers indicate like elements.

### DETAILED DESCRIPTION OF THE INVENTION

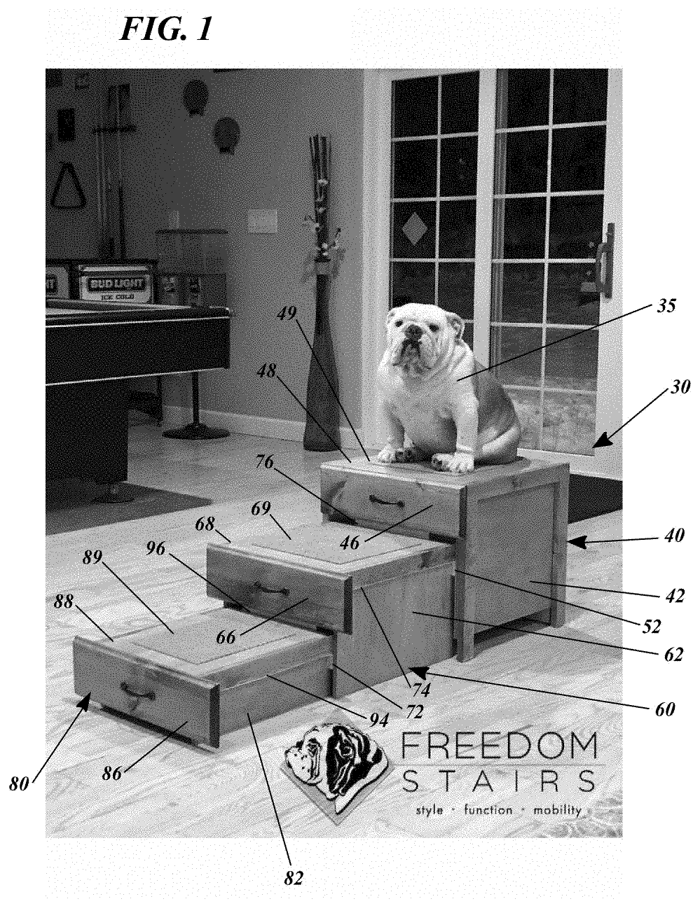

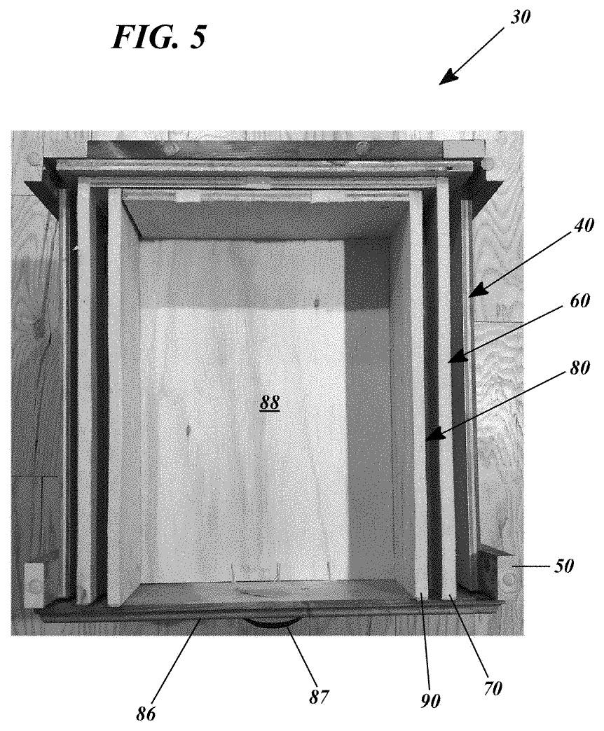

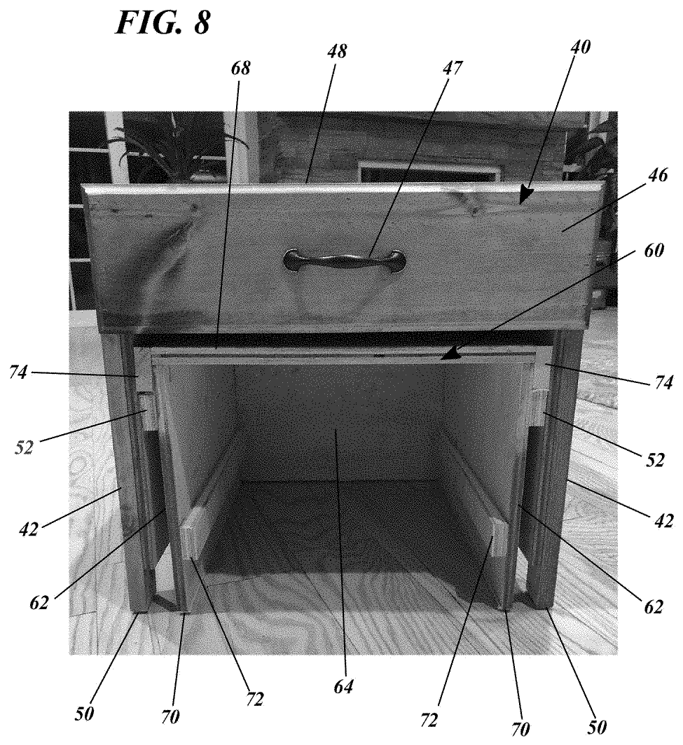

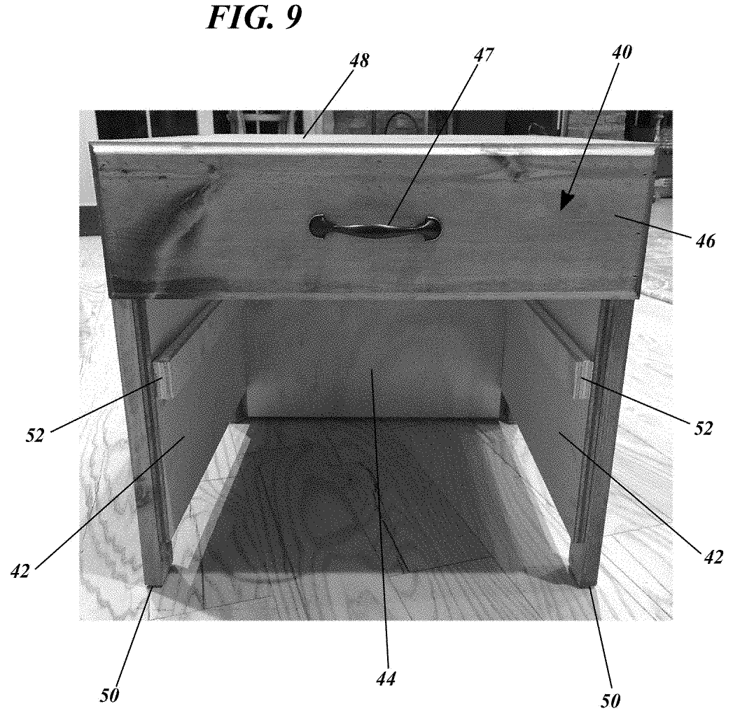

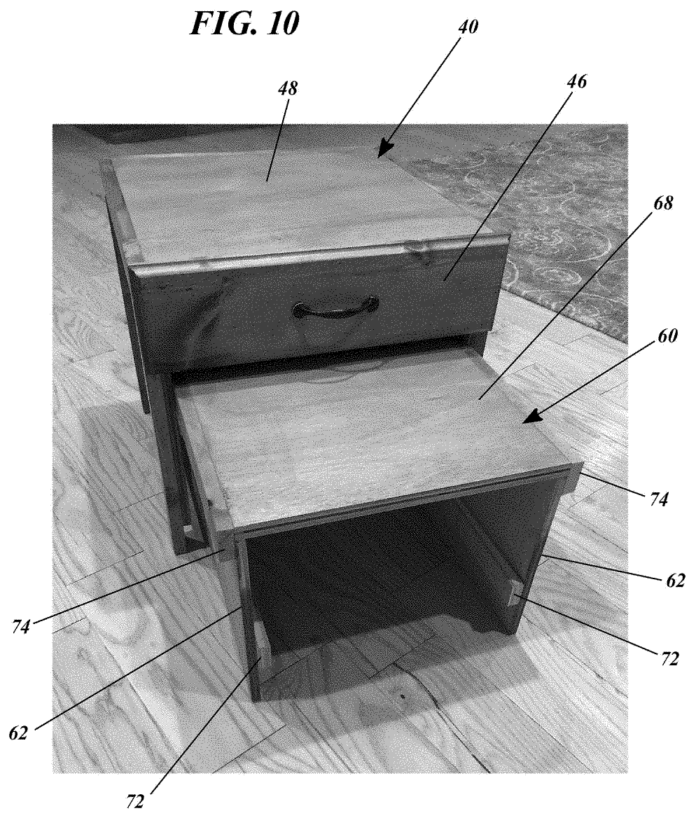

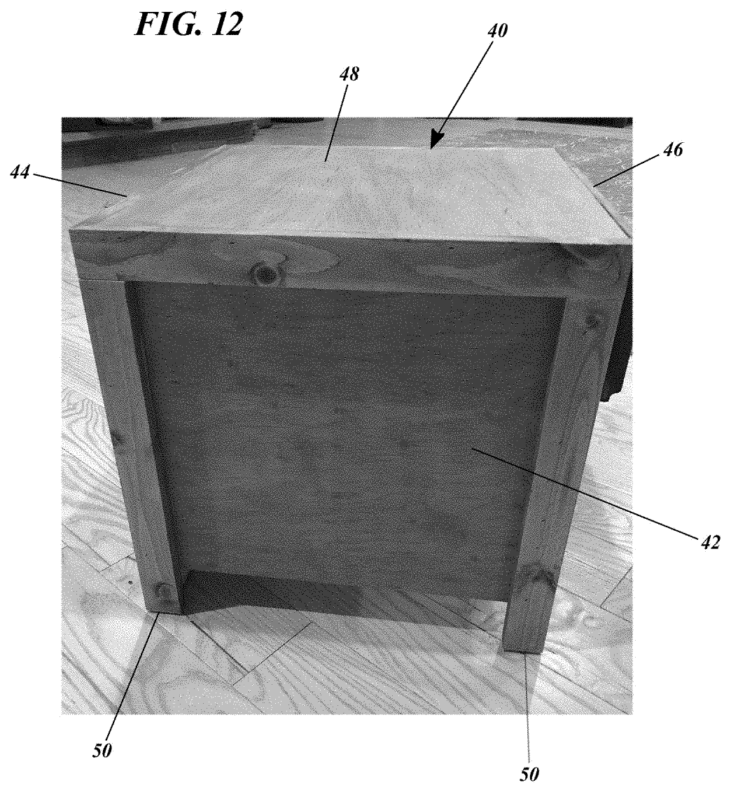

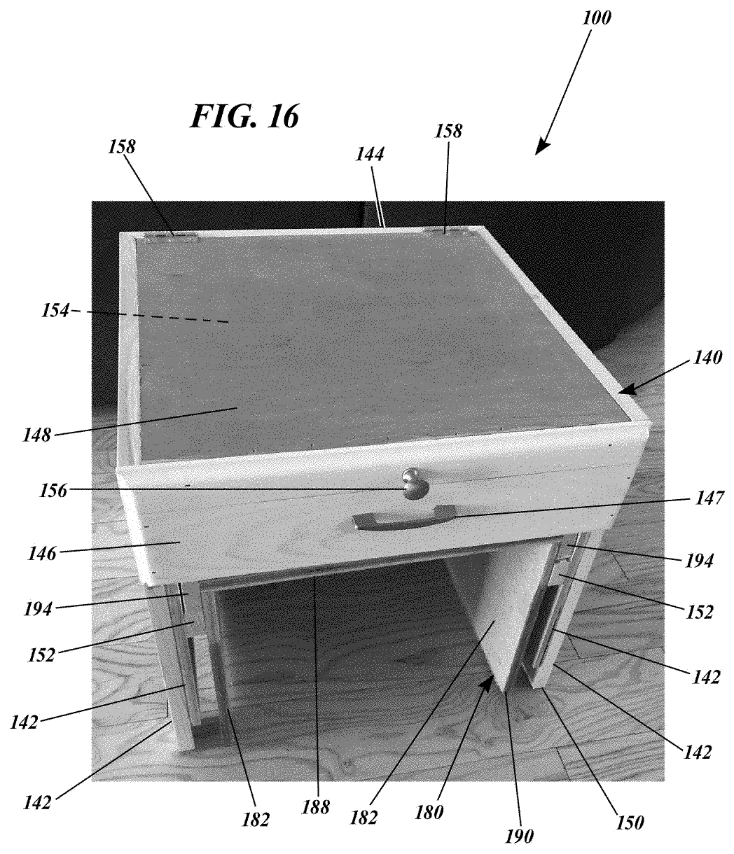

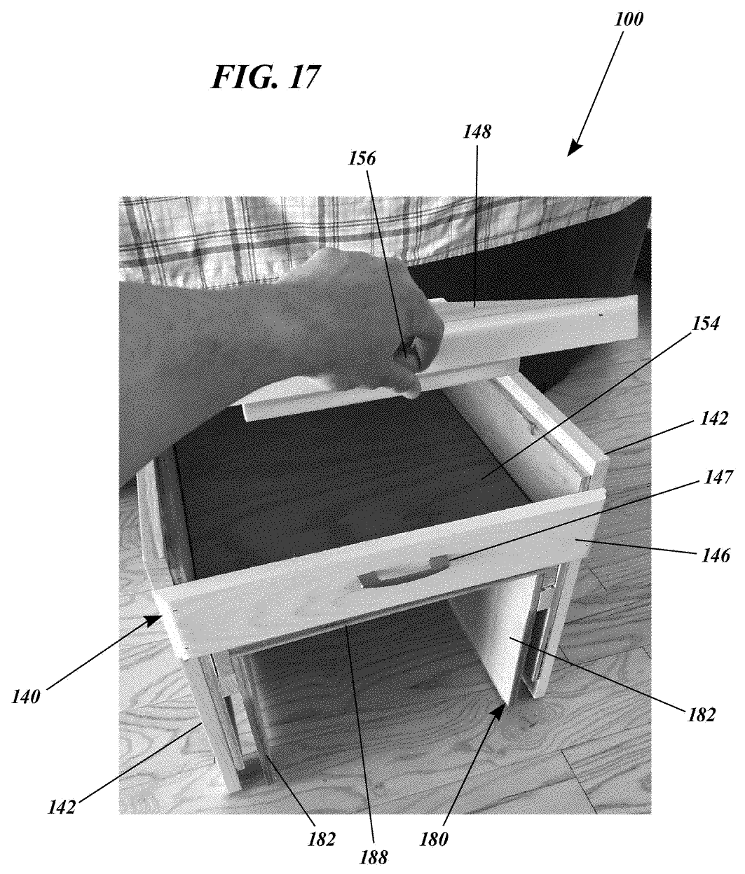

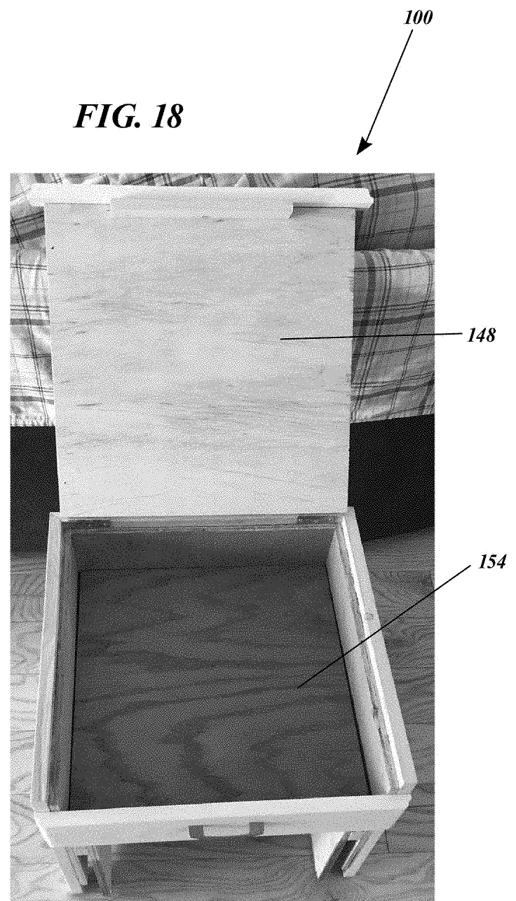

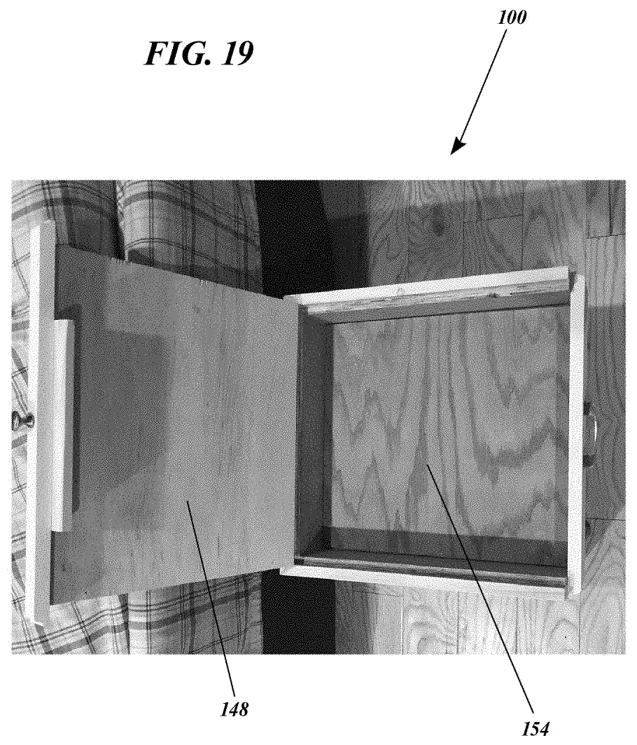

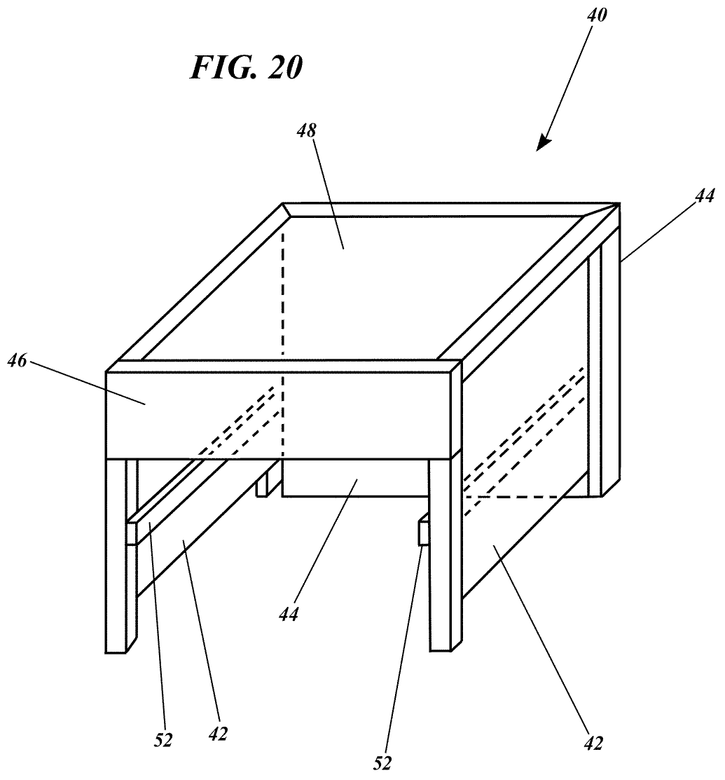

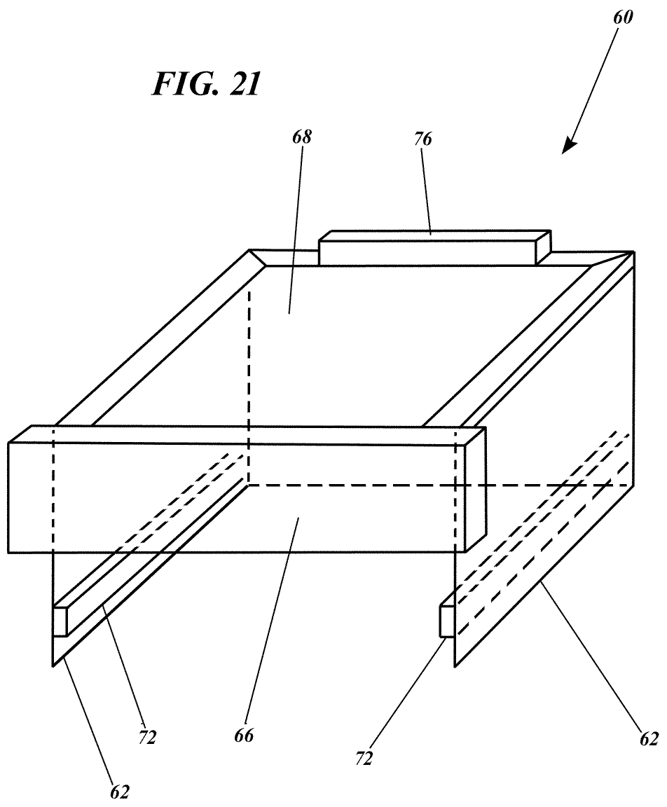

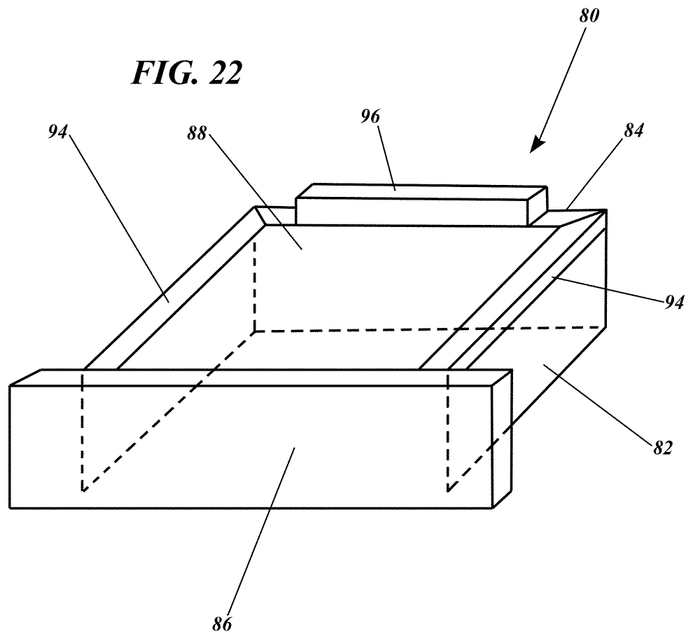

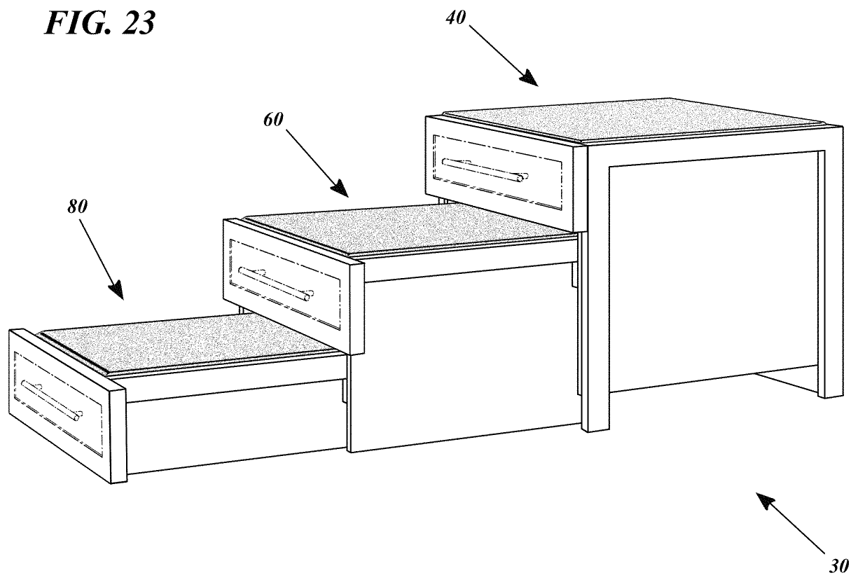

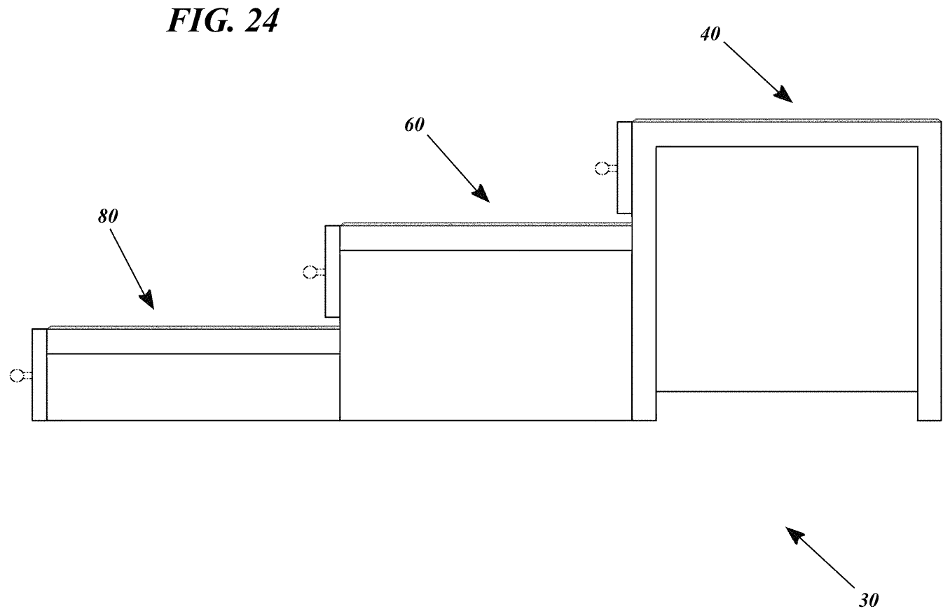

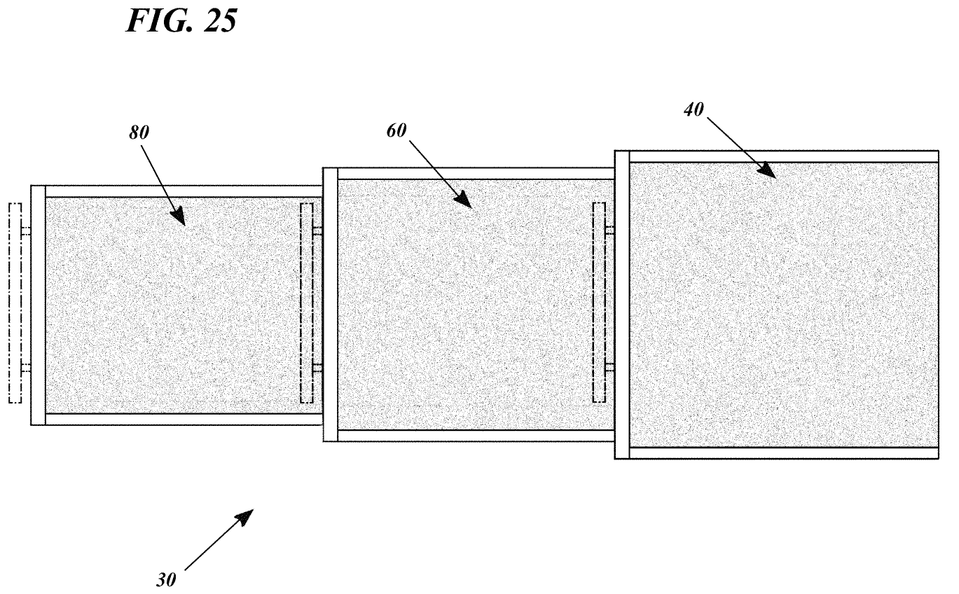

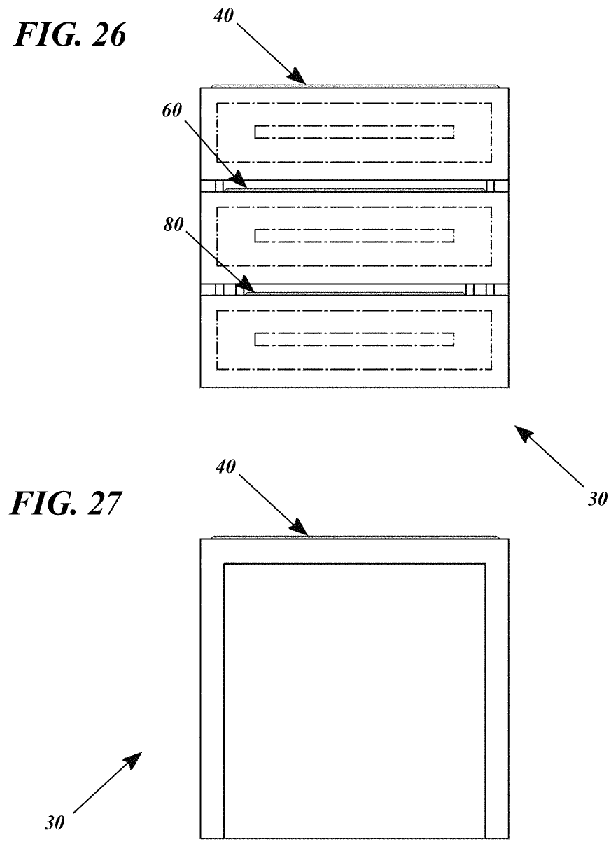

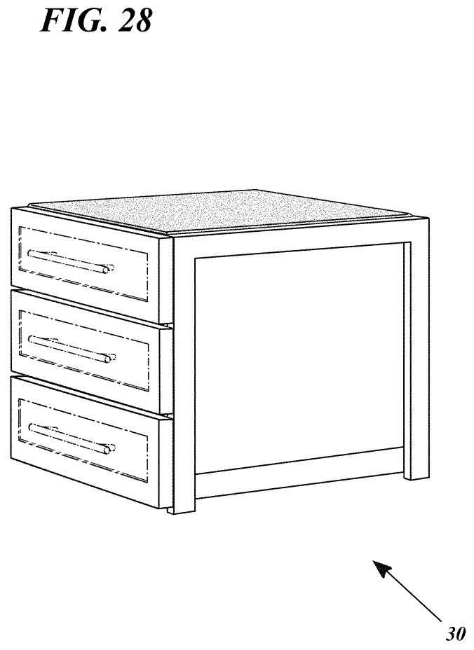

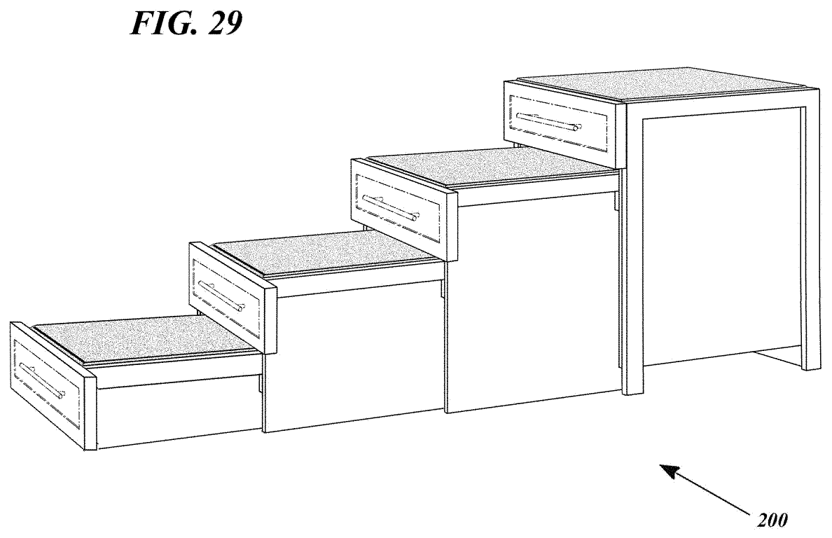

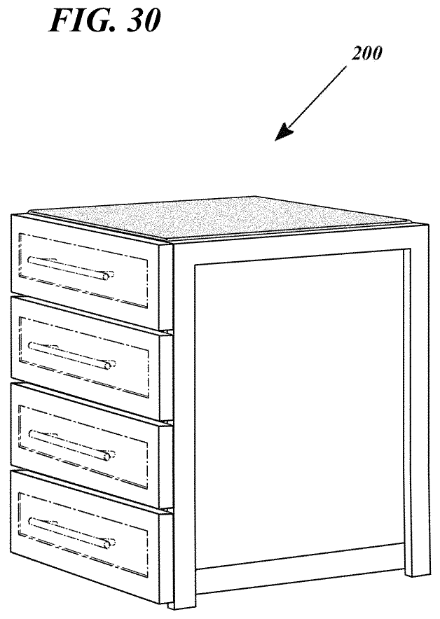

FIGS. 1 through 15 and FIGS. 20 through 28 are directed to a first embodiment of the pet steps of present invention that is comprised of a three step staircase for easy accessibility of pets, i.e., a retractable step stool for pets that rests on a floor and is slidable across the floor. FIGS. 16 through 19 are directed to a second embodiment of this invention that is comprised of a two-step version similar to the first embodiment, and additionally has provision for a storage space below the top step. FIGS. 29 and 30 are directed to a third embodiment of this invention that is comprised of a four-step version similar to the first embodiment. All these embodiments will be described in greater detail below. It should be noted that in some of the drawings the front panels have been removed for clarity and understanding.

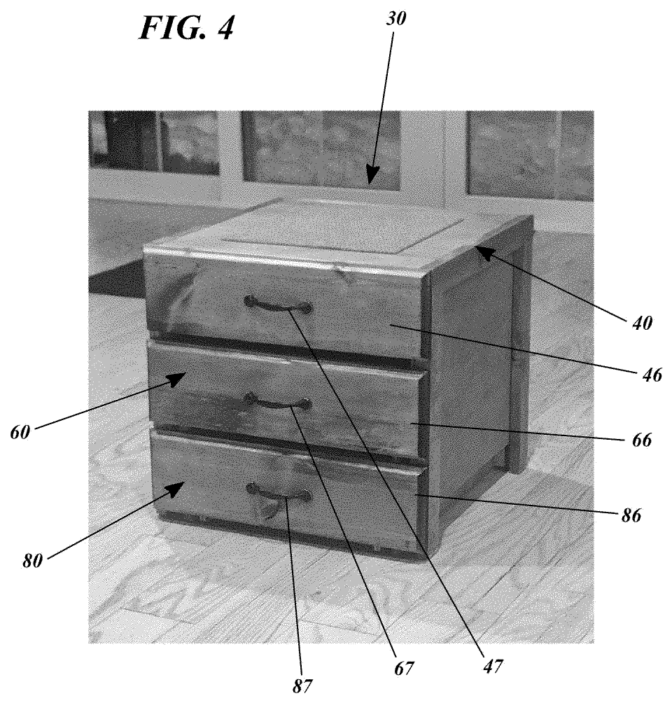

Referring to the first embodiment shown in FIG. 1, the staircase or retractable step stool for pets is shown generally as 30 and is comprised of main base cabinet and top or first step 40, a middle step or second step 60 and a bottom step or third step 80. In FIGS. 1-3, the staircase 30 is shown in an open expanded position wherein all the steps have been extended to allow for the pet 35 to progress up and down steps 40, 80, and 60. The pet 35 sits perched on top or first step 40. FIG. 4 shows the staircase or pet steps 30 in a closed, collapsed position with steps 60 and 80 pushed inwardly to reside inside of the main base cabinet or top step 40. FIGS. 1 through 4 show the staircase in the open and closed configurations.

Referring to FIGS. 1-15 and FIGS. 20-28, the pet steps of this invention comprise a main base cabinet and top or first step 40 that has two side panels 42, rear panel 44, front upper panel 46 and top step or top surface 48. Front panel 46 has a handle 47 and top 48 that has a textured surface 49 which can be carpet or any other non-skid means to prevent the pet from slipping on the top surface 48 or to provide a soft surface to lie on.

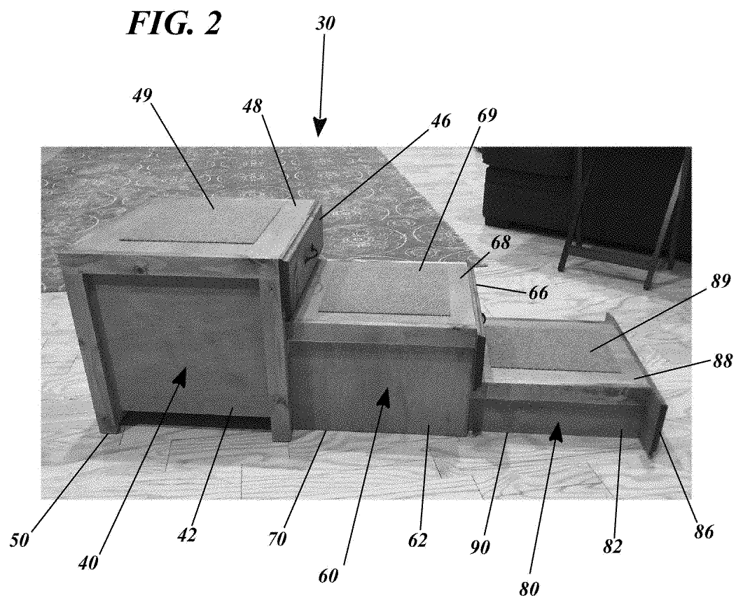

Referring for example to FIGS. 2, 5 and 6, the bottom surface 50 is the area of contact with the floor and is the lowermost portion of side panels 42 and rear panel 44. Internal side rails 52 are located on the interior of sidewalls 42 and are designed to interface with related rails 74 of middle step 60 for alignment and support of the middle step 60.

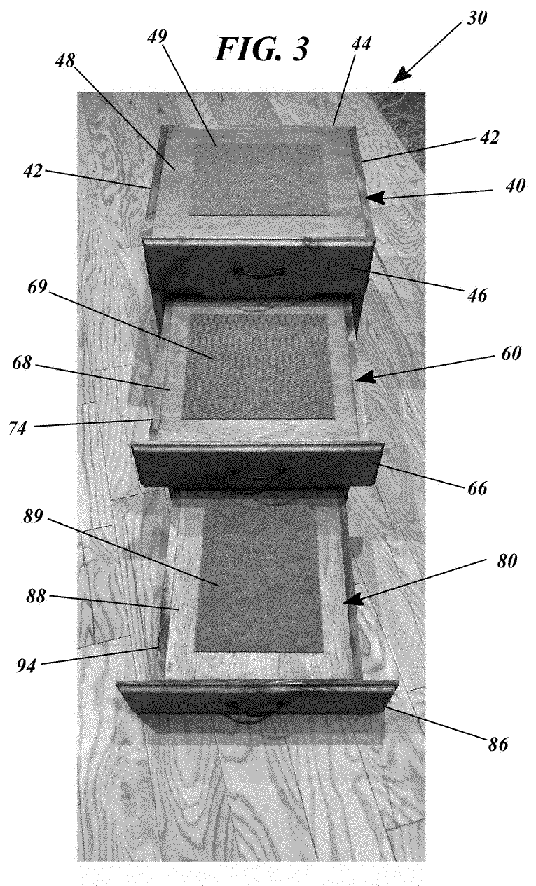

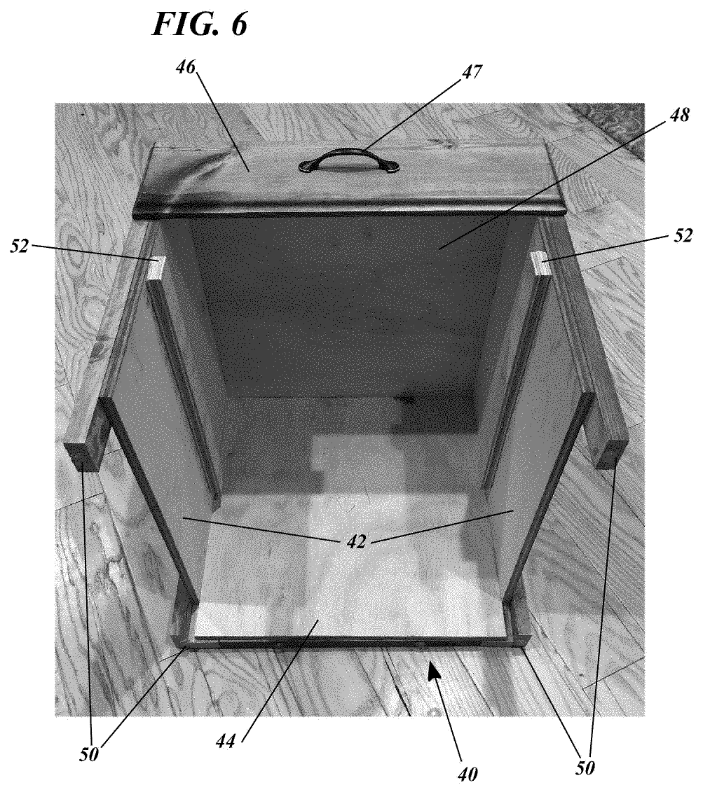

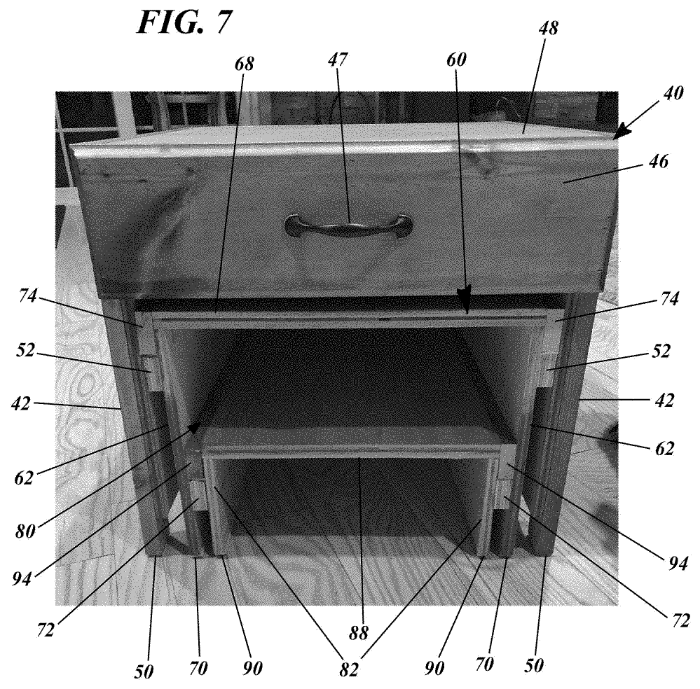

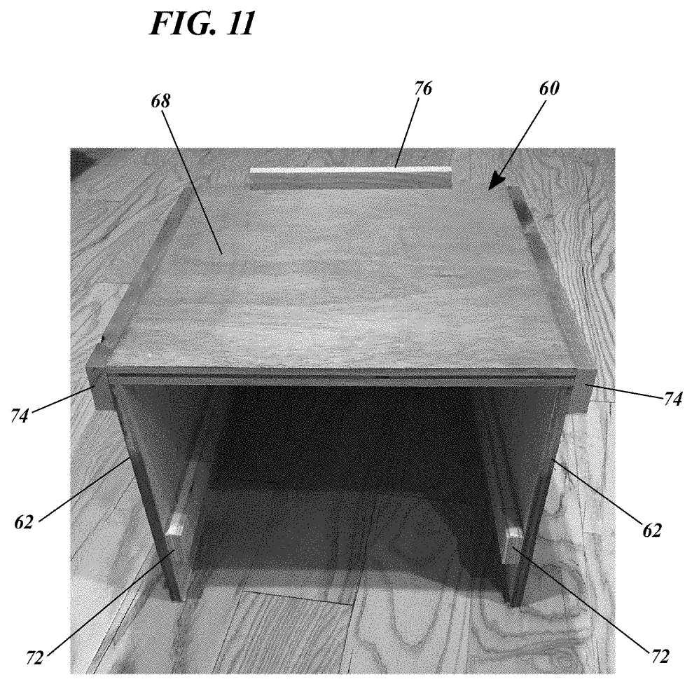

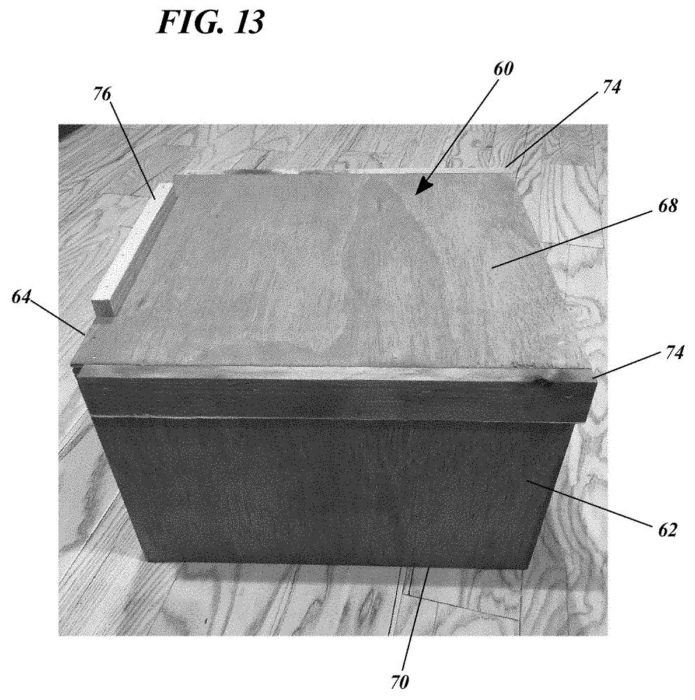

Referring to FIGS. 11 and 13, middle step 60 includes two side panels 62, rear panel 64, front upper panel 66 and top 68. Referring to FIGS. 3, 4, and 10, front panel 66 has a handle 67 and top 68 has a textured surface 69 which can be carpet or any other non-skid means to prevent pets from slipping. The bottom surface 70 is the area of contact with the floor is the lowermost portion of side panels 62 and rear panel 64 and are adapted to be slidably supported on the floor. Referring to FIGS. 6 and 7, internal side rails 72 are located on the interior of sidewalls 42 and are designed to interface with external rails 94 of lower step 80 for alignment and support purposes. External rails 74 located on the outside of sidewalls 62 interface with internal rails 52 of top step 40 for alignment and support purposes.

Referring to FIGS. 1 and 11, a stop 76 is provided at the rear edge of 68 in order to prevent the step 60 from disengaging with top step 40 by way of contact with the interior surface of front panel 46. This can be seen in FIG. 1.

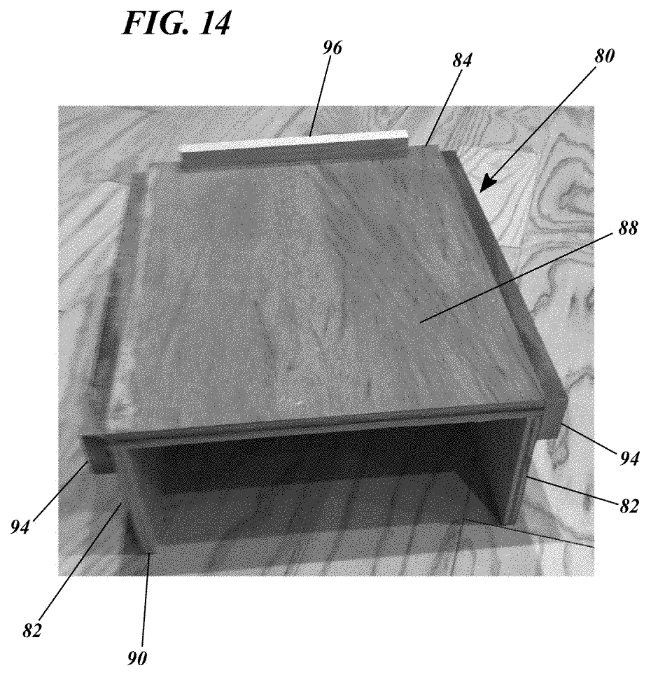

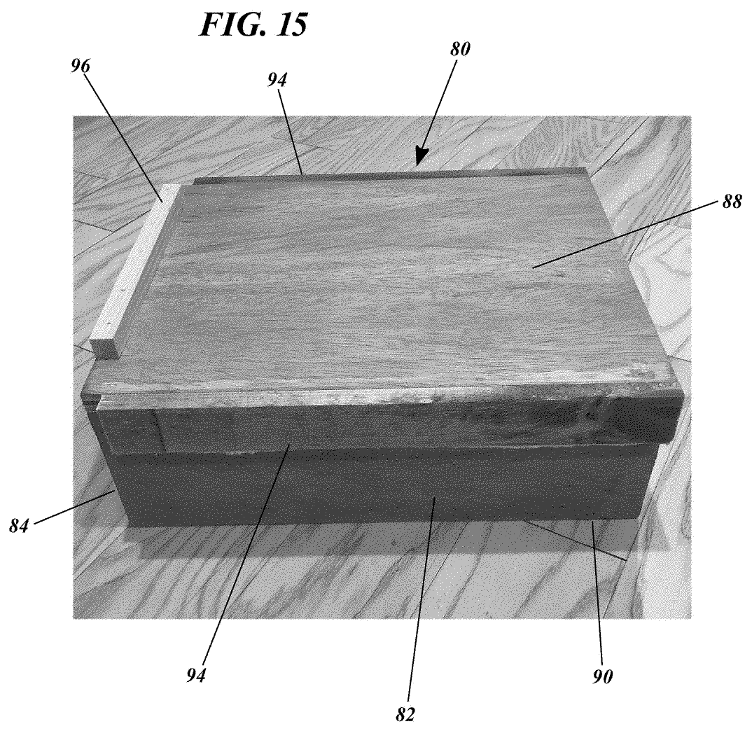

Referring to FIGS. 14 and 15, the third bottom step 80 includes two side panels 82, a rear panel 84, and front upper panel 86 and top 88. As seen in FIGS. 1, 3 and 4, front panel 86 has a handle 87 and top 88 having a textured surface 89 thereon which can be a carpet or any other non-skid means to prevent the pet from slipping. The bottom surface 90 is the area of contact with the floor and is the lowermost portion of side panels 82 and rear panel 84 and are adapted to be slidably supported on the floor. External rails 94 located on the outside of sidewalls 82 interface with internal rails 72 of second middle step 60 for alignment and support purposes. Additionally, a stop 96 is provided at the rear edge of 88 in order to prevent the step 80 from disengaging with middle step 60 by way of contact with the interior surface of front panel 86. This can be seen in FIG. 1.

In operation the staircase 30 would be positioned adjacent the desired area that the pet owner wishes to allow their pet 35 access to, such as a bed, couch or otherwise and by pulling out the third lower step 80 and then pulling out the second middle step 60 until stops 76 and 96 contact front panels 66 and 86 respectively. This assures full extension of the staircase 30 for a stable environment for pet 35 to traverse safely up and down staircase 30 as needed or desired.

The support of the pet steps 30 while opened or collapsed does not rely on the side rails 52, 72, 74 and 94 of steps 40, 60 and 80, respectively, to physically support the weight of the pet steps 30 and the pet 35. The pet steps 30 are supported by the closely spaced and aligned bottom surfaces 50, 70 and 90 of steps 40, 60 and 80 to be in contact with the floor surface to support the weight of the pet steps 30 and, for example, a relatively heavy dog 35 as depicted in FIG. 1. Additional means such as nylon glides and or felt and the like could be implemented to assist in smooth operation. Further enhancements such as wheels and so forth could be included to assist in portability and placement of the staircase 30.

FIGS. 16 through 19 are directed to a two-step staircase or pet step 100 that is comprised of a main base cabinet top step 140 and a bottom step 180. This embodiment is similar in structure to the first embodiment but is a lower height profile and additionally provides for a storage space beneath the top step. It should be noted that in some of the drawings the front panels have been removed for clarity and understanding.

Still referring to FIGS. 16 through 19, main base cabinet and top step 140 has two side panels 142, rear panel 144, front upper panel 146 and top 148. Front panel 146 has a handle 147 and top panel 148 that can be opened using knob 156 to expose storage area 154 via hinges 158 attached to rear wall 144. The bottom surface 150 is the area of contact with the floor and is the lowermost portion of side panels 142 and rear panel 144 and are adapted to be slidably supported on the floor. Internal side rails 152 are located on the interior of sidewalls 142 and are designed to interface with related external rails 194 of lower step 180 for alignment and support purposes.

Bottom step 180 includes two side panels 182, rear panel 184, front upper panel 186 and top 188. Front panel 186 has a handle 187 and top 188. The bottom surface 190 is the area of contact with the floor and is the lowermost portion of side panels 182 and rear panel 184. External rails 194 located on the outside of sidewalls 182 interface with rails 152 of top step 140 for alignment and support purposes.

It is preferred that the external or outside rails 74, and 194 not continue all the way to the rear end of the step, see for example FIG. 13. This permits easy assembly of the steps. For example, external rails 74 and 194 are ⅛ inch shorter than of the full length of the step. This allows a 3 step staircase to become a 2 step, and a 4 step to become a 3 step if desired. With this design, keeping the cut out at the end of the external or outside rail permits each step to be similar to the other steps permitting the creation of similar plastic molds that can be assembled after each step is created.

Also, our stairs are designed to have a little movement in each step. By that I mean, the steps do not fit into each other tightly. There must be a little wiggle room. The reason for this is because dogs obviously won't use the staircase the same way properly all the time. They get excited, they jump, they run; for this reason, and since this may be an all wood product, to keep the rails themselves from coming loose or breaking off we allow the steps to be able to move slightly from side to side (right to left) to accommodate the inconsistent use from pets.

A primary feature of the invention is the increased step tread dimension for a four legged pet. As can be seen in the drawings the depth of each step is much deeper than a conventional step for both human use and other steps designed for pets. The rise is the vertical dimension between the floor or each landing or step. The tread is the horizontal dimension from the front of the step to the next rise. All current pet staircases follow the standard rise and tread of a 7″×11″ step which are engineered for human use. They are too small for four legged pets and especially pets with health and geriatric issues. The staircase, retractable step stool or pet steps of the present invention have a rise of 6″ with a minimum 16″ tread, and as long as 24″ so a pet can stand on each step. This creates a more comfortable ascent and a more safe descent down the stairs. It is easier on their joints because it keeps the dog in a less angled position going up or down the stairs. The proportions of the current invention can be scaled to accommodate animals and pets of many sizes from small to large simply by adjusting the dimensions of the related rise and tread of each step in order to provide sure footing.

| ELEMENT NUMBER | ELEMENT NAME |
|---|---|
| 30 | First Embodiment Overall -3 Step Pet Step. |
| | Retractable Step Stool for Pets |
| 35 | Pet |
| 40 | Main Base Cabinet (top step) - Overall |
| 42 | Sidewalls of 40 |
| 44 | Rear Wall of 40 |
| 46 | Front Wall Panel/Drawer Face of 40 |
| 47 | Handle on 46 |
| 48 | Top Panel/Step of 40 |
| 49 | Textured Surface (Carpet) of 48 |
| 50 | Bottom Surface of 40 |
| 52 | Internal Side Rails to Support 60 |
| 60 | Middle Step - Overall |
| 62 | Sidewalls of 60 |
| 64 | Rear Wall of 60 |
| 66 | Front Wall Panel/Drawer Face of 60 |
| 67 | Pull Handle on 66 |
| 68 | Top Panel/Step of 60 |
| 69 | Textured Surface (Carpet) of 68 |
| 70 | Bottom Surface of 60 |
| 72 | Internal Rails to Support 80 |
| 74 | External Rails to glide on 52 |
| 76 | Stop at rear edge of 68 |
| 80 | Bottom Step - Overall |
| 82 | Sidewalls of 80 |
| 84 | Rear Wall of 80 |
| 86 | Front Wall Panel/Drawer Face of 80 |
| 87 | Pull Handle on 86 |
| 88 | Top Panel/Step of 80 |
| 89 | Textured Surface (Carpet) of 88 |
| 90 | Bottom Surface of 80 |
| 94 | External Rails to ride on 72 |
| 96 | Stop at rear edge of 88 |
| 100 | Second Embodiment Overall- 2 Step Pet Step |
| | Retractable Step Stool for Pets |
| 140 | Main Base Cabinet (top step) - Overall |
| 142 | Sidewalls of 140 |
| 144 | Rear Wall of 140 |
| 146 | Front Wall Panel/Drawer Face of 140 |
| 147 | Handle on 146 |
| 148 | Top Panel/Step of 140 |
| 150 | Bottom Surface of 140 |
| 152 | Internal Side Rails to Support 180 |
| 154 | Storage Space (below 148) |
| 156 | Knob/Handle to access 154 |
| 158 | Hinges for 148 |
| 180 | Bottom Step - Overall |
| 182 | Sidewalls of 180 |
| 184 | Rear Wall of 180 |
| 186 | Front Wall Panel/Drawer Face of 180 |
| 187 | Pull Handle on 186 |
| 188 | Top Panel/Step of 180 |
| 190 | Bottom Surface of 180 |
| 194 | External Rails to ride on 152 |
| 196 | Stop at rear edge of 188 |

Applicant contemplates that the pet steps of this invention may be made of any material suitable for such invention, including but not limited to plastics, wood, or stiff cardboard. Additionally, it is contemplated that electronics and computer aided technology may be used to expand and collapse the steps, move the pet steps from one location to another and to use a mobile device, e.g., iPad or iPhone, smart phone, etc. to control the pet steps.

The invention has been described with reference to various specific and illustrative aspects of the present invention and techniques. However, it should be understood that many variations and modifications may be made while remaining within the spirit and scope of the invention. Many alternatives, modifications and variations will be apparent to those skilled in the art in light of the foregoing description. Accordingly, this invention is intended to embrace all such alternatives, modifications, and variations that fall within the spirit and scope of the description.

1. A retractable and collapsible step stool for pets that rests on a floor and is slidable across the floor comprising:
a. a first step having a first upper panel having a first front edge, a first rear opposing edge and first opposing side edges;
a first rear support member mounted along the first rear edge extending to the floor;
a first side support member mounted along each of the first opposing side edges, each extending to the floor;
wherein the first rear support member and first side support members are of substantially equal length to provide a substantially horizontal first upper panel that is slidably supported on the floor;
b. a second step having a second upper panel having a second front edge, a rear second opposing edge and second opposing side edges;
a second rear support member mounted along the second rear edge extending to the floor,
a second side support member mounted along each of the second opposing side edges, each extending to the floor;
wherein the second rear support member and second side support members are of substantially equal length to provide a substantially horizontal second upper panel that is slidably supported on the floor;
wherein the second rear support member and second side support members are sufficiently shorter than the first rear support member and first side support members and the second upper panel is sufficiently smaller than the first upper panel to permit the second step to selectively slide under the first step to collapse the step stool and extend from under the first step to retract the step stool.

2. The step stool of claim 1, wherein the second step is slidably and removably mounted to the interior of the first step.

3. The step stool of claim 1, further comprising an internal slide rail mounted to each of the first side support members slidably mating with an external slide rail mounted to each of the second side support members.

4. The step stool of claim 1, further comprising:
a. a first front panel having an upper edge and a lower edge, the upper edge of the first front panel mounted along the first front edge of the first upper panel and the lower edge of the first front panel extending downward from the first upper panel;
b. a first stop member mounted along the second rear edge of the second upper panel;
wherein the first stop member and the lower edge of the first front panel are spaced sufficiently apart to permit the second step to selectively slide under and extend from under the first step and the first stop member prevents disengagement of the second step from the first step.

5. The step stool of claim 1, wherein the first or second step has a provision below the first top tread panel or second top tread panel for an accessible storage compartment.

6. The step stool of claim 1, wherein each of the first and second tread panels has a non-skid textured surface.

7. A retractable and collapsible step stool for pets that rests on a floor and is slidable across the floor comprising:
a. a first step having a first upper panel having a first front edge, a first rear opposing edge and first opposing side edges;
a first rear support member mounted along the first rear edge extending to the floor;
a first side support member mounted along each of the first opposing side edges, each extending to the floor;
wherein the first rear support member and first side support members are of substantially equal length to provide a substantially horizontal first upper panel that is slidably supported on the floor;
b. a second step having a second upper panel having a second front edge, a second rear opposing edge and second opposing side edges;
a second rear support member mounted along the second rear edge extending to the floor;
a second side support member mounted along each of the second opposing side edges, each extending to the floor;
wherein the second rear support member and second side support members are of substantially equal length to provide a substantially horizontal second upper panel that is slidably supported on the floor;
wherein the second rear support member and second side support members are sufficiently shorter than the first rear support member and first side support members and the second upper panel is sufficiently smaller than the first upper panel to permit the second step to selectively slide under the first step to collapse the step stool and extend from under the first step to retract the step stool;
c. a third step having a third upper panel having a third front edge, a third rear opposing edge and third opposing side edges;
a third rear support member mounted along the third rear edge of the third upper panel extending to the floor;
a third side support member mounted along each of the third opposing side edges of the third upper panel, each extending to the floor;
wherein the third rear support member and third side support members are of substantially equal length to provide a substantially horizontal third upper panel that is slidably supported on the floor;
wherein the third rear support member and third side support members are sufficiently shorter than the second rear support member and second side support members and the third upper panel is sufficiently smaller than the second upper panel to permit the third step to selectively slide under the second step to collapse the step stool and extend from under the second step to retract the step stool.

8. The step stool of claim 7, wherein the second step is slidably and removably mounted to the interior of the first step and the third step is slidably and removably mounted to the interior of the second step, wherein each step may be separated from the other steps.

9. The step stool of claim 7, further comprising:
a. an first internal slide rail mounted to each of the first side support members slidably mating with a second external slide rail mounted to each of the second side support members;
b. an second internal slide rail mounted to each of the second side support members slidably mating with a third external slide rail mounted to each of the third side support members.

10. The step stool of claim 7, further comprising:
a. a first front panel having an first upper edge and a first lower edge, the first upper edge of the first front panel mounted along the first front edge of the first upper panel and the first lower edge of the first front panel extending downward from the first upper panel,
b. a first stop member mounted along the rear edge of the second upper panel, wherein the first stop member and the first lower edge of the first front panel are spaced sufficiently apart to permit the second step to selectively slide under and extend from under the first step, the first stop member preventing disengagement of the second step from the first step;
c. a second front panel having a second upper edge and a second lower edge, the second upper edge of the second front panel mounted along the second front edge of the second upper panel and the second lower edge of the second front panel extending downward from the second upper panel;
d. a second stop member mounted along the third rear edge of the third upper panel, wherein the second stop member and the second lower edge of the second front panel are spaced sufficiently apart to permit the third step to selectively slide under and extend from under the second step and the second stop prevents disengagement of the third step from the second step.

11. The step stool of claim 7, wherein at least one of the first, second or third steps has a provision below the first, second or third upper panel for an accessible storage compartment.

12. The step stool of claim 7, wherein each of the first, second and third upper panels has a non-skid textured surface.
